(19) United States
(12) Patent Application Publication
(10) Pub. No.: US 2002/0091031 A1
(43) Pub. Date: Jul. 11, 2002

(54) Johnson - positive action continuous traction (p.a.c.t) vehicle differential

(76) Inventor: Gary Carlton Johnson, Columbus, OH (US)

Correspondence Address: Gary C. Johnson, P.O. Box 10855, Columbus, OH, 43201, US

(21) Appl. No.: 10/021,656

(22) Filed: Dec. 12, 2001

Related U.S. Application Data
(60) Provisional application No. 60/254,901, filed on Dec. 12, 2000.

(51) Int. Cl. F16H 48/06

(52) U.S. Cl. 475/221

(57) ABSTRACT

The invention relates to a new vehicle differential that will rotate both axle sections under all conditions. Having positive traction capabilities and still allow variability between axle sections.

### BACKGROUND OF THE INVENTION

This invention relates to a better vechicle differential, that prevents wheel slippage and wheel immobility.

On heavy-duty vehicles, limited slip differentials are not practicle. Heavy-duty vechles often use locking mechanisms to keep both axle sections rotating continuously, which is not always practical either, variability is disrupted

This new differential can use gears for drive force.

### SUMMARY OF THE INVENTION

The new differential provides positive rotation to each axle section of a vehicle, under all road conditions, when the vehicle is on a level surface.

It will still allow variability between axle sections when needed on a curved path, but only allowing inversely proportional rotation, which is one of the advantages of the new differential.

The new differential, when used one for each set of drive axle sections, and being inversely installed; having the two different drive mechanism of one differential, diametrically opposed to the two different drive mechanisms of the other differential, will only allow diametrical wheel/axle section roll-back. Therefor at least one wheel on the left or right of the vehicle will have constant rotation capability.

### BRIEF DESCRIPTION OF THE DRAWINGS

FIG. 1 is a cross sectional view of the said new differential.

### DETAILED DESCRIPTION OF THE DRAWINGS

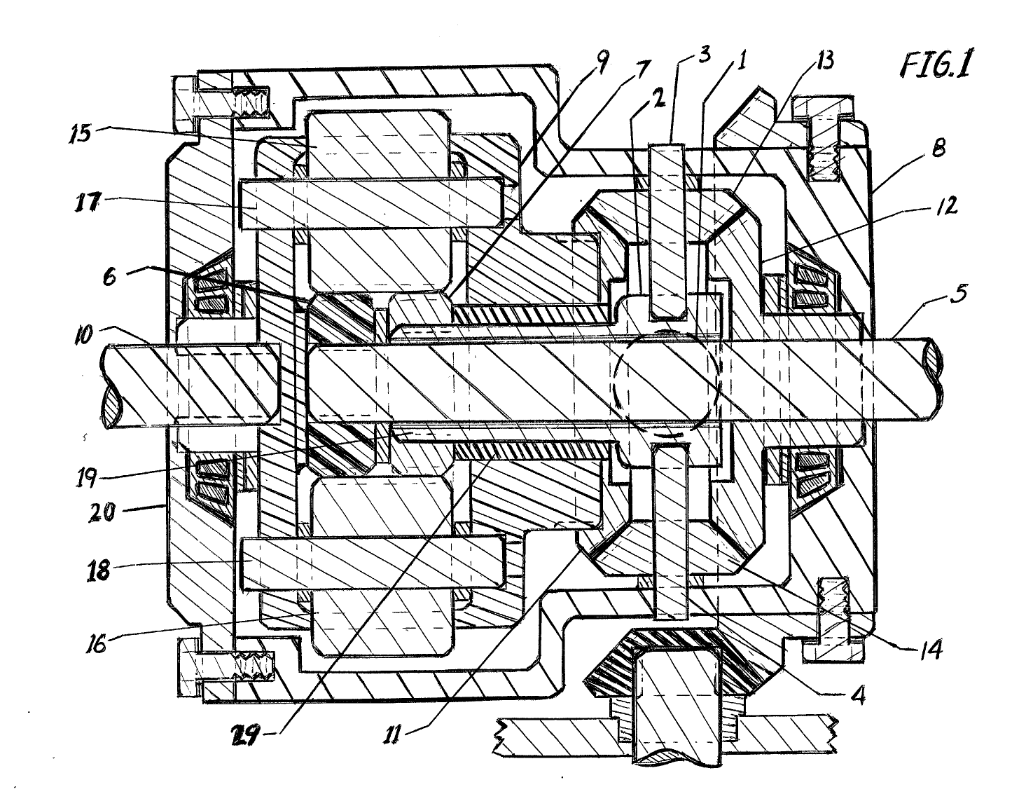

In FIG. 1, the support member 1 supports the central case member 2, the case member 2 is the final resting place for pinion shafts 3 and 4. the axle shaft 5, has a gear 6 splined to it's end. The gear 7 is rotatively stationary to the pinion case 8, being splined to the shaft 19. The shaft 19 being fixed to the central case member 2. The planetary gear case 9, having an axle shaft 10 splined to one of it's axial openings. The gear case 9 having a bevel gear 11 fixed/splined to it's other end. A bevel gear 12 being splined to axle shaft 5. the pinion gears 13 and 14 being rotatively stationary to the main case 8. The gear case 9, having an axle shaft 10 splined to one of it's axial openings . The gear case 9 having a bevel gear 11 fixed/splined to it's other end. The gear case 9 having orbital gears 15 and 16 rotatively stationary to the said case 9 by way of shafts 17 and 18 respectively. The end plate 20 is for the entrance and containment of most of the members of the said new differntial. The member 29 is a flat bearing.

In FIG. 1, wherein if one of either axle sections were to resist mobility, the faster rotating gear 6 or 7 will counter rotate the orbital gears 15 and 16, therein counter rotating the case 9 and it's splined axle shaft, therein the differential only allowing inversely proportional rotation.

I claim, a new differential having:

1. a pinion differential incorporated with planetary gearing.

2. a new differential having: a pinion differential incorporated with planetary gearing, the planetary gearing having a rotatable case/fixture of it's own.

3. a new differential having: a pinion differential incorporated with planetary gearing, the planetary gearing having a rotatable case/fixture of it's own, the said case being stationary/fixed to one of the axle bevel gears.
